(19) United States
(12) Patent Application Publication
(10) Pub. No.: US 2026/0148024 A1
(43) Pub. Date: May 28, 2026

(54) ELECTRICAL CONTROL SYSTEM

(71) Applicant: J Kolter STEVENSON, Manhattan, MT (US)

(72) Inventor: J Kolter STEVENSON, Manhattan, MT (US)

(21) Appl. No.: 19/397,091

(22) Filed: Nov. 21, 2025

Related U.S. Application Data
(60) Provisional application No. 63/725,905, filed on Nov. 27, 2024.

(51) Int. Cl. G06K 7/10; G06K 19/07; G06K 19/077

(52) U.S. Cl. CPC G06K 7/10405; G06K 19/0723; G06K 19/07707

(57) ABSTRACT

In one embodiment, a system can include a housing defining an internal volume, a display screen coupled to the housing, and a recess defined by the housing. The system can further include a processor disposed within the internal volume, a plurality of input mechanisms, and an antenna disposed within the internal volume.

### CROSS REFERENCE TO RELATED APPLICATIONS

This application claims the benefit of priority under 35 U.S.C. § 119(e) and 37 C.F.R. § 1.78 to provisional application No. 63/725,905 filed on Nov. 27, 2024, titled “ELECTRICAL CONTROL SYSTEM” which is hereby incorporated by reference herein in its entirety.

### TECHNICAL FIELD

The present disclosure generally relates to systems electrical control systems. More particularly, the present disclosure relates to an RFID system for a heating and electrical control system.

### BACKGROUND

Colleges and military instillations can have various multitenant residential facilities that can include a multitude of separate rooms with individual users in each of the separate rooms. In each room, electronic devices can be integrated to change power heat usage of the individual space. For example, the temperature of each room can be individually adjusted, and the lights of each room can be adjusted. Consequently, as each room is individually controlled by its individual user, an administrator of the multitenant house cannot control the energy waste of each room, thereby increasing energy waste. For example, when a user is not in the room, the temperature can remain at the user's settings, lights can be left on, and electronic devices can be running. Thus, there is an increased usage in energy as the user is not in the room. Current technology currently utilizes motion sensing technology, mechanical systems, or geolocation technology to control the settings of each room to determine when a user is present or not present in the room to slow energy waste. However, current technology that utilizes motion sensing technology or geolocation technology cannot be easily controlled by the user for accurate tracking or control. Therefore, there is a need for a physical central control system that can administer energy use of each individual room, particularly in a multitenant installation.

### SUMMARY

In one embodiment, a system can include a housing defining an internal volume, a display screen coupled to the housing, and a recess defined by the housing. The system can further include a processor disposed within the internal volume, a plurality of input mechanisms; and an antenna disposed within the internal volume.

In one example, the recess can receive at least a portion of a Radio Frequency Identification (RFID) card. In one example, the processor can collect a power usage data, determine a RFID signature of a user, and determine a user setting based on the RFID signature of the user. The user setting comprises at least one of temperature, lights, power usage, or connected electronic devices. In one example, the plurality of input mechanisms can be mechanical buttons. In another example, the plurality of input mechanisms can be a touch sensitive layer. In one example, the system can further include an RFID reader disposed in the recess. The antenna communicatively couples to electronic devices via Bluetooth or Wi-Fi or other wireless networks (IoT).

In one embodiment, a method of the system can include receiving an RFID card in a recess defined by a housing of an electronic device communicatively coupled to a centralized control system. The method further includes determining a user's settings based on a RFID signature of a specific user, and communication the user's setting to electronic devices communicatively coupled to the centralized control system.

In one example, the method can further include controlling a user's settings via an electronic device communicatively coupled to the centralized control system. The user's settings include a user's temperature preferences, a user's light preferences, and a user's operations of electronic devices communicatively coupled to the centralized control system. The method further includes changing a standard setting to the user's setting via an RFID signature. In one example, the method can further include returning the user's settings to the standard settings as the RFID card is removed from the centralized control system. The method further includes collecting a user's energy usage as the RFID card received by the housing and sharing the power usage data with electronic devices communicatively coupled to the centralized control system.

In one embodiment, a method can include collecting power usage data from a plurality of electronic devices coupled to a centralized control system, aggregating the power usage data, comparing the aggregated power usage data to a weather prediction, and adjusting a standard setting for the plurality of electronic devices.

In one example, the method can further include viewing the aggregated power usage data from the centralized control system. In one example, the weather prediction can comprise of at least one of temperature, humidity, atmospheric pressure, or precipitation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

Other advantages of the present invention are readily appreciated as the same becomes better understood by reference to the following detailed description when considered in connection with the accompanying drawings wherein:

FIG. 1A illustrates a front view of one example of a thermostat;

FIG. 1B illustrates a front view of one example of a thermostat with an RFID card received;

FIG. 1C illustrates a top view of one example of a thermostat;

FIG. 2A is a schematic diagram of a plurality of one example of a thermostat communicatively coupled to the centralized control system and a user device;

FIG. 2B is a schematic diagram of one example of a plurality of thermostats, lights and electrical outlets communicatively coupled to the centralized control system and a user device;

FIG. 3 illustrates a flowchart for operation by a user of an electronic device;

FIG. 4 illustrates a flowchart for operation by an administrator of an electronic device;

FIG. 5 illustrates a schematic diagram of a multi-space environment authentication;

FIG. 6 illustrates a flow chart for a control priority;

FIG. 7 illustrates a schematic diagram of a load management system; and

FIG. 8 illustrates a flow chart for aggregated power usage data.

### DETAILED DESCRIPTION

Reference will now be made in detail to representative embodiments illustrated in the accompanying drawings. It should be understood that the following descriptions are not intended to limit the embodiments to one preferred embodiment. To the contrary, they are intended to cover alternatives, modifications, and equivalents as can be included within the spirit and scope of the described embodiments as defined by the appended claims.

The following disclosure generally relates to electrical control systems. More particularly, the present disclosure relates to an RFID system for an electrical control system. Colleges and military instillations utilize multitenant buildings that can include barracks, dormitories, or apartment style buildings. The multitenant buildings can include a multitude of individual rooms that individual users can reside in. The users residing in the individual rooms of current multitenant buildings can control the temperature, the number of electronic devices connected to the multitenant buildings power network and control the operations of lights, temperature, and power draw within the room when the user is within the room or not within the room. In this way, individual users'power consumption can vary from user to user, and individual users can consume more energy than other individual users. In this example, an individual user can consume energy while not present in the room of the multitenant building. In this way, the user can be cooling or heating a room while not present, leave lights on in the room while not present, and/or leave electronic devices running (e.g., a television, computer, fan, or any other suitable electronic device) while not present in the room. In this way, energy can be consumed and be considered wasted energy. Temperature control is a major source of energy use in multitenant housing. Current technology currently utilizes motion sensing technology or geolocation technology to control the settings of each room to determine when a user is present or not present in the room to slow energy waste. However, current technology that utilizes motion sensing technology or geolocation technology cannot be easily controlled by the user or building administrator for accurate tracking or control. Therefore, the system and methods described herein, are designed for an administrative user to control a standard setting and a system within the room controlled by the user to mitigate energy consumption in multitenant housing.

In one example, a system can include a housing defining an internal volume, a display screen coupled to the housing, and a recess defined by the housing. In one example, the system can be defined by a thermostat, a plug, a light switch, or any other suitable device that can include a recess. For this example and throughout the specification the system can be referred to as the system or a thermostat. This is a non-limiting example of the system. In one example, the recess can be configured to receive at least a portion of a Radio Frequency Identification (RFID) card. In this example, military personnel and college students are issued identification cards that can be configured to be RFID cards. In this way, the military personnel and college students can insert their issued RFID identification cards into the recess of the system. The system can further include a processor disposed within the internal volume of the housing, a plurality of input mechanism, and an antenna disposed within the internal volume. In this example, the processor can be configured to determine an RFID signature of a user as the user inserts at least a portion of the RFID card into the recess. The processor can determine a user setting based on the RFID signature of the user.

In one embodiment, a method can include receiving the RFID card in a recess defined by the housing of a centralized control system. The centralized control system can determine a user's settings based on the RFID signature of the RFID card and communicate the user's settings to electronic devices communicatively coupled to the centralized control system. In one example, the electronic devices can include a thermostat, electrical plugs, lights, and any other suitable electronic devices. In this way, the centralized control system can communicate with a thermostat to set the temperature of the room to a user's preference, power on lights based on a user's preferences, or power on outlets for use with other electronic devices (e.g., television). In one example, the centralized control system can communicate with user electronic device (e.g., smart phone, tablet, laptop, smartwatch, etc.) via a network such that the user settings can be changed or updated. In this example, the centralized control system can communicate with the user electronic device to display power usage reports.

In one embodiment, a method can include setting a standard setting for all electronic devices communicatively coupled to a centralized control system. In this way, an administrative user (e.g., security personnel, management personnel, or any other suitable administrative user) can communicatively couple to the centralized control system of each system within each room of the multitenant housing. In this example, the administrative user can set a standard setting, for example, a set room temperature as an RFID card is not received by the system discussed above. In this way, the administrative user controls the standard settings (e.g., room temperature, light status, outlet status, etc.) to control the individual rooms while the user is not present, thereby decreasing the amount of energy consumed. The method can further include collecting power usage data from the centralized control system and can view the power usage data on a user electronic device (e.g., smart phone, tablet, laptop, smart watch). In this way, an administrative user can view power usage data of all rooms in the multitenant building to work with users of the individual rooms to mitigate power usage of each room.

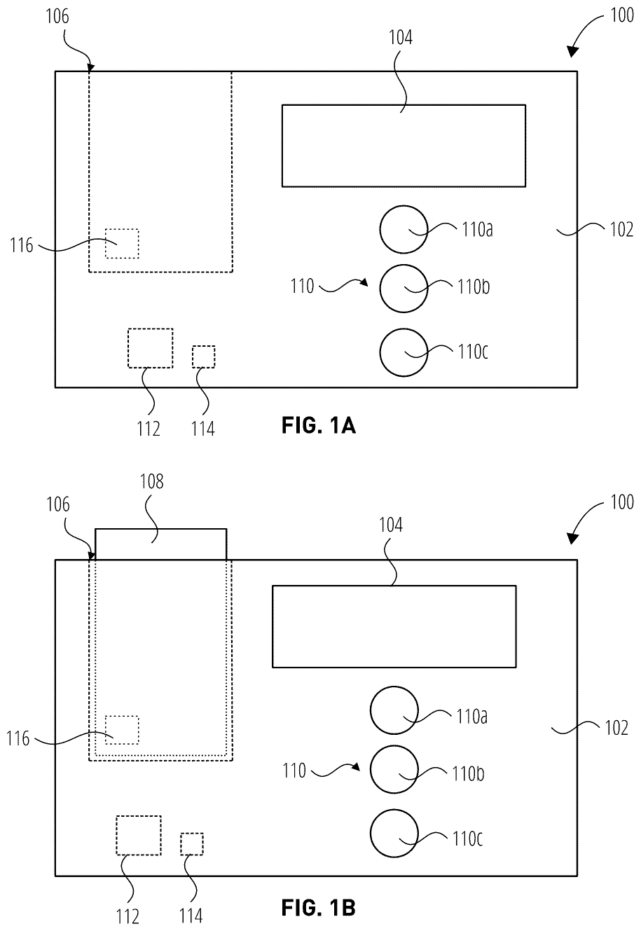

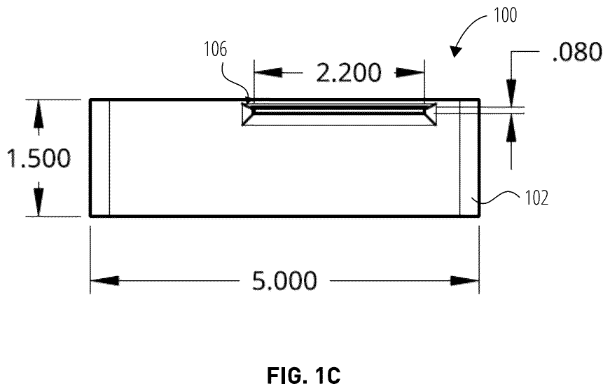

These and other embodiments are discussed below with reference to FIGS. 1-8. However, those skilled in the art will readily appreciate that the detailed description given herein with respect these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A illustrates a front view of one example of a system or a thermostat 100. A non-limiting example of the system is shown in the figures as a thermostat 100. In one example, the system can be defined as a light switch, an electrical plug, an electronic control panel, or any other electrical device within a housing unit. In one example, the thermostat 100 can include a housing 102 that can define an internal volume 103. The thermostat 100 can include a display screen 104. The display screen 104 can be Organic light emitting diode (OLED), light emitting diode (LED), liquid crystal display (LCD), quantum dot displays, or any other suitable type of display screen. As illustrated in FIG. 1A, the display screen 104 can be disposed on the front face of the housing. In another example, the display screen 104 can be configured to cover the entirety of the front face. In one example, the display screen 104 can include a touch-sensitive layer such that the touch-sensitive layer can be configured to receive an input from a user based on a registered force input.

In one example, the thermostat 100 can further include a recess 106 defined by the housing 102. In this example, the recess 106 can be configured to receive at least a portion of an RFID card. In one example, military personal and college students can be issued a user identification card that can be configured to include RFID technology. An RFID card works by using radio waves to wirelessly transmit data between a card and a reader. In one example, the recess 106 can include an RFID reader 116. In one example, the RFID card can establish a wireless connection between the card and the reader 116 and once the connection is established the card can transfer data back to the reader 116. As discussed in more detail below, a RFID card can include data including a user's custom setting that can be communicated with the reader in the thermostat 100 as the RFID card is inserted. In one example, RFID cards can be configured to a rectangular shape, for example, the size of a credit card. In one example, the typical size of the RFID card can be a width of 3-3.5 inches, a height of 2-2.5 inches, and a thickness of 0.03-0.05 inches. As illustrated in FIG. 1A, the recess 106 can be defined in a rectangular shape as to receive an RFID card in a rectangular shape. It should be understood, the recess 106 can be configured as to receive an RFID card of any size or shape. FIG. 1B illustrates a front view of one example of a thermostat 100 with an RFID card 108 received. FIG. 1C illustrates a top view of one example of a thermostat 100. As illustrated in FIG. 1C, the recess 106 can be defined by the housing 102 to the thickness and height of the RFID card 108 as to secure the RFID card 108 into the housing 102 of the thermostat 100. In one example, the entirety of the RFID card 108 can be secured within the recess 106 of the housing 102 or a portion of the RFID card 108 can be secured within the recess 106 of the housing 102. As illustrated in FIG. 1B, the RFID card 108 can be partially inserted into the recess 106 of the housing 102 as to simplify the removal of the RFID card 108 by the user. As illustrated in FIGS. 1A, 1B, and 1C, the recess 106 is configured to receive a rectangular RFID card 108, for example, a rectangle card the size of a credit card.

In one example, the thermostat 100 can include a plurality of input mechanisms 110. As illustrated in FIGS. 1A and 1B, the thermostat 100 can include a first input mechanism 110a, a second input mechanism 110b, and a third input mechanism 110c. FIGS. 1A and 1B is a non-limiting example as the thermostat 100 can include a plurality of input mechanism 110. In one example, the first input mechanism 110a can be a power button, the second input mechanism can be a directional control button (e.g., up, left, right, or down), and the third input mechanism can be a direction control button (e.g., up, left, right, or down). In one example, the input mechanisms 110 can be configured to any suitable configuration for control of the thermostat 100. In one example, the input mechanisms 110 can be configured to control the set temperature of the air condition. In one example, the plurality of input mechanisms 110 can be mechanical buttons such as to provide a user feedback and increase the ease of manufacturing. In another example, the plurality of input mechanisms 110 can be a touch sensitive layer. In this way, the inputs respond to a user's input force. The thermostat 100 can further include a haptic feedback engine (not illustrated) to provide a user feedback with a touch sensitive layer. In one example, the thermostat can include no input mechanisms 110 as the thermostat 100 can be communicatively coupled to an external electronic device that can control the thermostat 100 wirelessly.

In one example, the thermostat 100 can include a processor 112 disposed within the internal volume 103 of the housing 102. The thermostat 100 can further include an antenna 114 disposed within the internal volume 103 of the housing 102. The processor 112 can include, a controller, at least one memory component and at least on antenna 114, and or one or more other components. For example, the controller, the memory component, the antenna 114, and the other components can all be operably connected with or to the processor 112. The electrical coupling that allows the processor 112 to receive data, control, and/or utilize the controller, the memory component, the antenna 114, and the other components can be described as being operably connected. Additionally, the controller, the memory component, the antenna 114, and the other components can all be operably connected with or to each other, for example via an electrical coupling, and with or to other components of the thermostat 100. The antenna 114 can receive signals and can transmit the signals to the other components of the processor 112, e.g., the controller. The other components can include wires, logic boards, electronic connections, and flexes, or any other electronic or non-electronic component utilized by the processor 112 for operation. One or more processors 112 can be electrically coupled to one or more memory components, which store electronic instructions that, when executed, cause the processor 112 to conduct the various functions, outputs, and methods described throughout the present disclosure.

In one example, the processor 112 can be electrically coupled to an RFID reader 116, as discussed above, and the processor 112 can be configured to determine an RFID signature of a user based on the data transferred by the RFID card 108 to the RFID reader 116. In one example, the RFID signature can be a unique signature assigned to each individual user. In this example, the processor 112 can be configured to determine a user's setting based on the RFID signature. In one example, a user's settings can include a user's set temperature of the room, a user's preferred lights, a user's operations of electronic devices communicatively coupled to thermostat 100, power operations of an electrical plug, or any other suitable settings. In this example, the antenna 114 can be configured to communicatively couple to electronic devices via Bluetooth or Wi-Fi. In this example, the thermostat 100 can communicatively couple to the user's personal electronic device (e.g., smartphone, tablet, smartwatch, laptop, etc.) or administrator's personal electronic device (e.g., smartphone, tablet, smartwatch, laptop, etc.) via Bluetooth or Wi-Fi and the antenna 114 of the thermostat 100 can further communicatively couple with any electronic device within the room (e.g., smart outlets, televisions, smart lightbulbs, thermostat, or any other suitable electronic devices). In this way, as the RFID card 108 is in communication with the RFID reader 116 the processor 112 can determine the user setting based on the RFID signature of the user and the antenna 114 can communicate with the couple electronic devices to update the operation statuses to that of the user's settings. As discussed in more detail below, the thermostat 100 and antenna 114 can be communicative coupled to the network that can connect with any electrical device on the network.

In yet another example, the processor 112 can be configured to collect a power usage data. In this example, all electronic devices communicatively coupled to the processor 112 and thermostat 100 can share the power usage data of the electronic device (i.e., plug, switch, or thermostat) over a selected amount of time. In one example, the power usage data can be calculated and displayed on the user's electronic device or the administrator's electronic device, for example, via an application on the electronic device, as to monitor the power usage.

In one example, the thermostat 100 can include a sensor (not illustrated) electrically coupled to the processor 112. In one example, the sensor can be configured to detect a temperature of the room the thermostat 100 is housed in. In this example, the sensor can communicate the temperature to the processor 112 as to change the temperature of the room to the preset temperature when the temperature of the room is different from the preset temperature. In one example, the sensor can be configured to detect the humidity within the room. In this example, the sensor can detect humidity levels and provide an alert if the detected humidity is outside a normal threshold.

Any of the features, components, and/or parts, of the system or method, including the arrangements and configurations thereof shown in FIG. 1A-1C, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1A-1C.

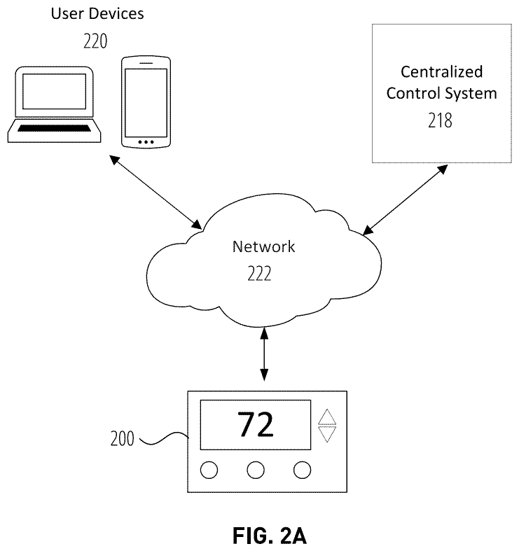

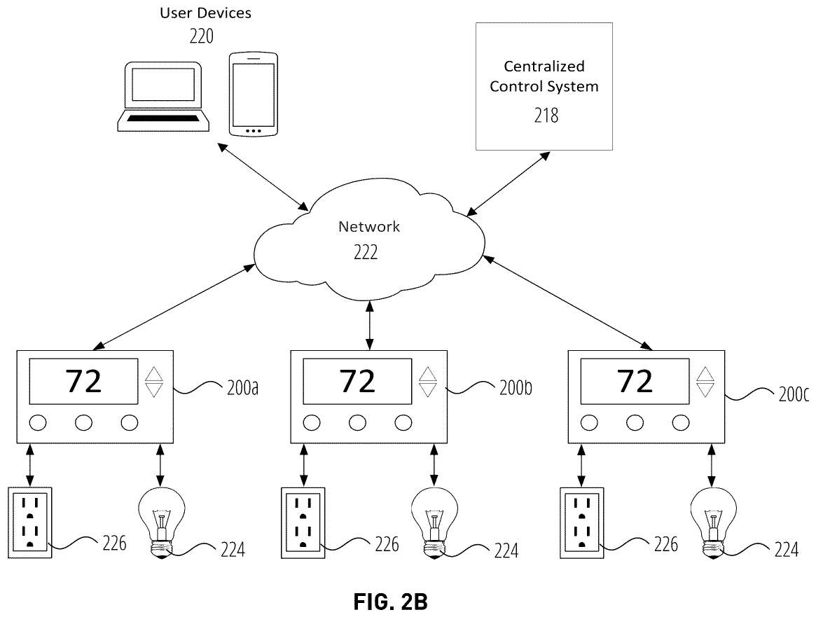

FIG. 2A is a schematic diagram of one example of a thermostat 200 communicatively coupled to a centralized control system 218 and a user device 220. As illustrated in FIG. 2A, the thermostat 200 can be wirelessly coupled to the network via Bluetooth, Wi-Fi, wired connection, or any other suitable connection type. In one example, the network can be a local area network (LAN), a wide area network (WAN), personal area network (PAN), a storage area network (SAN), or any other suitable network type. As illustrated in FIG. 2A, the network 220 can be communicatively coupled to the centralized control system 218. In one example, the centralized control system 218 may be implemented by a computing device (e.g., computer, laptop, smart phones, smart watch, etc.) or combination of computing resources in various embodiments. As illustrated in FIG. 2A, a user device (e.g., computer, laptop, smart phones, smart watch, or any other suitable electronic device) can communicatively connect to the network 218, the centralized control system 218 and the thermostat 200. In one example, the user devices 220 can provide input to, and receive output from, the thermostat 200. The user devices 220 in communication with the thermometer 200 can be devices belonging to the user residing the room or the security personnel or management personnel for accessing the thermometer 200. In one example, the user devices 220 can be authenticated by an authentication service prior to accessing the centralized control system 218 or thermostat 200. In one example, the centralized control system 218 can be implemented by one or more servers, cloud computing resources, and/or other computing devices.

In one example, a user device 220 can wirelessly communicate with the network 222 and the thermostat 200 such that the user device 220 can review power usage data shared by the thermostat 200. In yet another example, the user device 220 can wirelessly communicate with the thermostat 200 as to define the user settings such that when a RFID card is received by the thermostat 200 (not illustrated) the processor can communicate with electronic devices to set them at desired user settings. For example, the user can utilize the user device 220 to set the user's setting temperature to 72-degree Fahrenheit. In this way, when the user inserts the RFID card into the thermostat 200, the processor can communicate the user setting to the thermostat 200 as to adjust the temperature to the user setting temperature.

FIG. 2B is a schematic diagram of one example of a plurality of thermostats 200a, 200b, and 200c communicatively coupled to the centralized control system 218 and the user device 220. As illustrated in FIG. 2B, a plurality of thermostats 200a, 200b, and 200c can be communicatively coupled to the network 222. The plurality of thermostats 200a, 200b, and 200c can include electronic devices (e.g., smart outlets, light bulbs, televisions, or any other suitable electronic devices) wireless or wired and communicatively coupled to the thermostats 200. As illustrated in FIG. 2B, a smart lightbulb 224 and a smart outlet 226 can be communicatively coupled to the thermostats 200a, 200b, and 200c. Although not illustrated, it should be understood a plurality of different electronic devices can be communicatively coupled to the thermostat 200. In one example, the thermostats 200a, 200b, and 200c can define the operative status of the smart outlet 226 and the smart lightbulb 224. In one example, an administrative user can utilize a user device 220 to communicate with all thermostats 200a, 200b, and 200c in the multitenant building and set standard settings for each of the thermostats 200a, 200b, and 200c. In this example and discussed in more detail below, the administrative user can set a standard setting that controls all electronic devices connected to the thermostats 200a, 200b, and 200c and sets the power usage of the devices to a standard setting. In this way, the standard setting can be the operating settings while an RFID card is not coupled to the thermostats 200a, 200b, and 200c as to mitigate power waste while the user is not present in the room. In one example, the plurality of thermostats 200a, 200b, and 200c can further output data that can be communicated over the network to the centralized control system and the user devices. In this way, the user or administrative user can view the output data from the plurality of the thermostats 200a, 200b, and 200c on the user devices 220. In one example, the output data can include energy usage data.

Any of the features, components, and/or parts, of the system or method, including the arrangements and configurations thereof shown in FIG. 2A-2B, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2A-2B.

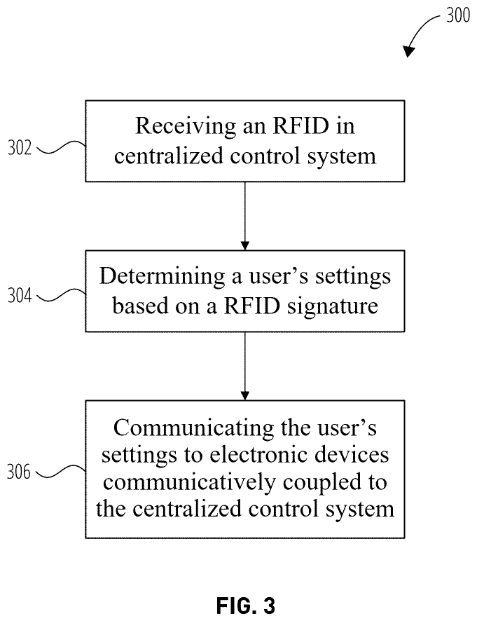

FIG. 3 illustrates a flowchart 300 for operation by a user of an electronic device, such as the thermostat 100 in FIG. 1A. In one example, the method can include receiving an RFID card in a recess defined by a housing of an electronic device (e.g., the thermostat 100 in FIG. 1A) communicatively coupled to the network and the centralized control system (Block 302). In this way, the RFID card can be inserted into the recess of the electronic device and the processor can determine the RFID signature. The processor of the electronic device can determine the user's settings based on the RFID signature of the RFID card (Block 304). The processor and antenna of the electronic device can communicate to other electronic devices in communication with the electronic device (e.g., the thermostat) via Bluetooth or Wi-Fi as to communicate the user's settings (Block 306). For example, the user can have a user setting temperature of 72 degrees Fahrenheit, and as the user inserts the RFID card into the electronic device the temperature of the thermostat can be changed to 72 degrees Fahrenheit without user input. As discussed below, the electronic devices connected to the centralized control system can include standard settings that can be set by an administrative user. In one example of the method, as the user inserts the RFID card and the RFID signature is accepted, the standard settings of the electronic devices can be changed to the user's settings. In this example, as the user removes the RFID card, the user's settings are changed to the standard settings.

Any of the features, components, and/or parts, of the system or method, including the arrangements and configurations thereof shown in FIG. 3, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

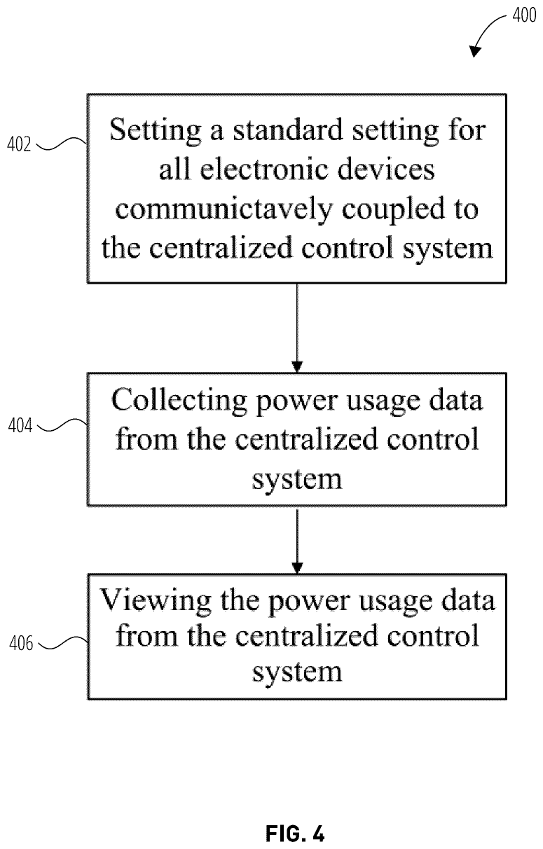

FIG. 4 illustrates a flowchart 400 for operation by an administrator of an electronic device (e.g., the thermostat 100 FIG. 1A). In one example, the method can include setting a standard setting for all electronic devices communicatively coupled to a centralized control system (Block 402). In this example, an administrative user can utilize a user device communicating over the network to the electronic devices throughout the rooms of a multitenant building and set a standard setting for all electronic devices. In this way, the standard setting can be the standard operating setting of the electronic devices, for example, the temperature of the thermostats set to 75 degrees Fahrenheit, when a user is not present in the room and an RFID card is not inserted into the electronic device. In one example, the standard settings for all electronic devices can be adjusted by a user device. In one example, the method can further include collecting power and environmental usage data from the centralized control system via the electronic devices (Block 404). In this example, the electronic devices (e.g., the thermostats) can output the power usage data through the network to the user devices of the administrative user or user. The administrative user or user can then view the power usage data output from the electronic devices on the user devices (Block 406).

Any of the features, components, and/or parts, of the system or method, including the arrangements and configurations thereof shown in FIG. 4, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

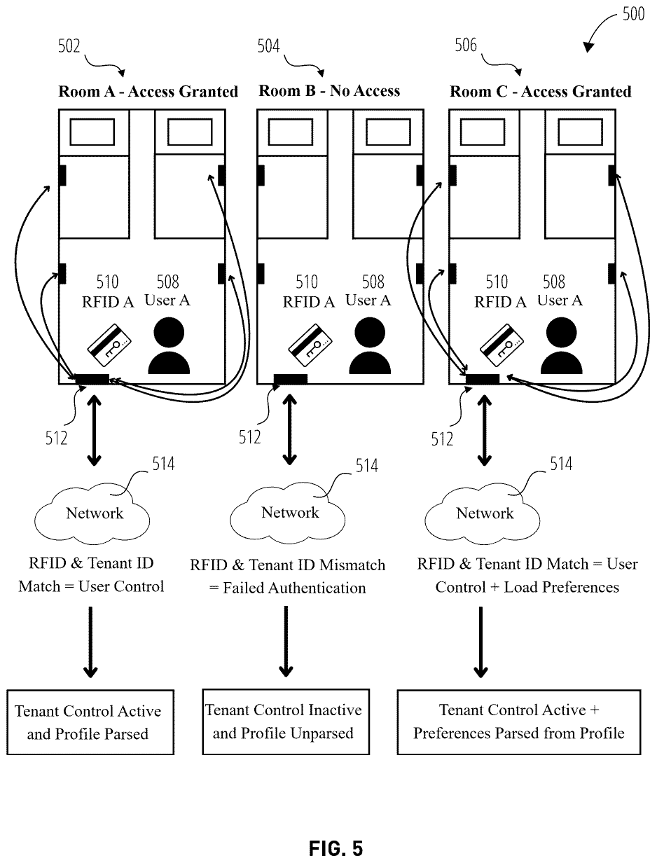

FIG. 5 illustrates a schematic diagram of a multi-space environment authentication 500. As illustrated in FIG. 5, room A 502, room B 504, and room C 506 illustrate a plurality of rooms within a military barracks, college dorm, or the like. In one example, a user A 508 can be a resident within the multitenant installation and the user A 508 can have an RFID card such as RFID A 510. The RFID A 510 can be linked to the user A 508 and include a RFID signature of the user A 508 and a user identity. The RFID A 510 can be inserted into or read by the electronic device 512. For example, the RFID A 510 can be inserted into the electronic device 512 that can be a thermostat within the room A 502, as discussed in detail herein. A processor of the electronic device can read the RFID signature of the RFID A 510 based on the data transferred by the RFID A 510. In one example, the RFID signature can be a unique signature assigned to each individual user. In this example, the processor can be configured to determine a user's identity and setting based on the RFID signature.

In one example, the user A 508 can insert the RFID A 510 into the electronic device 512 or otherwise have the RFID A 510 read by the electronic device 512 and the RFID signature and user identity can be a match, as illustrated in room A 510. In one example, the electronic device 512 can send information from the RFID card to a network 514 (which may be the same network as network 222 or may be a different network), wherein the network 514 can verify the user identity and user settings. Upon the matching of the RFID signature and the user identity, the user A 508 can control other electronic devices within the room. For example, the user A 508 can turn on the light, adjust the temperature, or plug electronic devices into electrical outlets after the verification of the RFID A 510.

In one example, the user A 508 can use the RFID A 510 in room B 504. The user A 508 can insert the RFID A 510 into the electronic device 512, wherein the electronic device 512 can be communicate with the network 514 to verify RFID signature and user identity. As illustrated in FIG. 5, the use of the RFID A 510 in room B 504 incurred an RFID and identity mismatch. Thus, the authentication failed, and the user A 508 does not have user control of the electronic devices within room B. In more detail, a user who lives in the multitenant instillation does not have access to other rooms that the user does not have permission to access as the RFID signature and user identity is specific for each assigned room.

In one example, the user A 508 can use the RFID A 510 in room C 506. The user A 508 can insert the RFID A 510 into the electronic device 512, wherein the electronic device 512 can be communicate with the network 514 to verify RFID signature and user identity. In this example, the RFID signature and the user identity is a match. Thus, the user A 508 can have control of the electronic devices within the room (e.g., the lights, the thermostat, the outlets, or the like). In this example, upon verification of the RFID signature and the user identity, the room C 506, and its electronic devices (e.g., the thermostat, the lights, the outlets, and the like) can change to a load preference or a user setting, as discussed in detail above. In more detail, upon verification the room can begin to apply climate controls such as heating up or cooling down, ventilating, opening blinds, lights can illuminate, outlets can be powered and the like, based on the user's settings, upon verification without the user intervention. As discussed in detail herein, after the verification of the user, the room's settings can switch from an administration setting to the user's settings. Once the RFID A 510 is removed, the devices can switch from the user's settings back to the administration settings. Thus, the electronic device 512 and the verification of the user can mitigate energy waste when a user is not present within the room.

Any of the features, components, and/or parts, of the system or method, including the arrangements and configurations thereof shown in FIG. 5, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

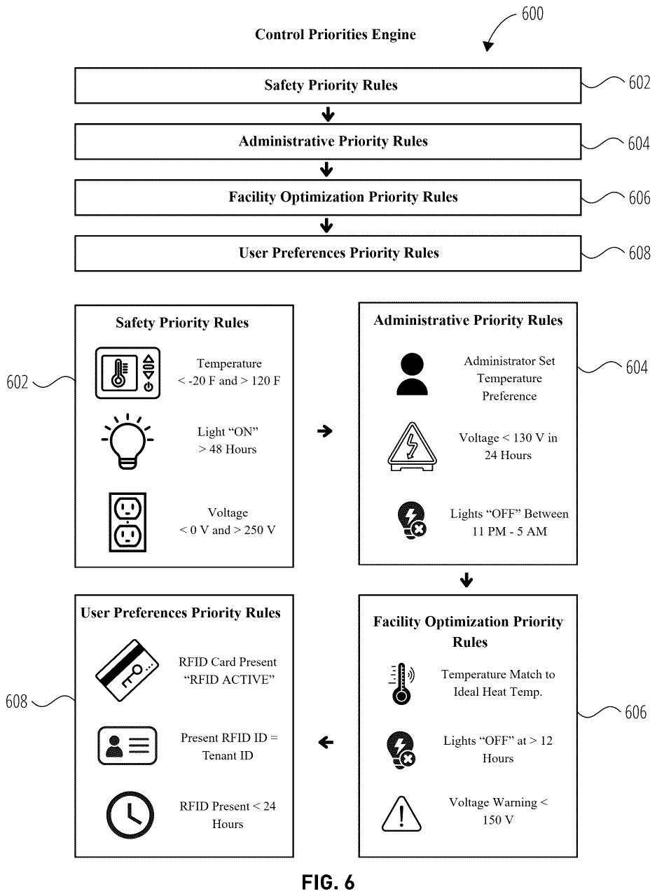

FIG. 6 illustrates a flow chart of a control priorities engine 600. The control priorities engine 600 can be a methodology or set of rules implied by a multitenant installation combined with the limitations of the present disclosure electronic device to mitigate unnecessary electricity waste within the multitenant instillation. The control priories engine 600 can control the rules and settings within a room within the multitenant installation. A safety priority rules 602 is the highest priority of rules within the operating system. The safety priority rules 602 can include a set of rules that can protect the room from damage that may be incurred from a lack of heating, cooling, and/or electricity issues, etc. In one example, the safety priority rules can control the temperature within the room such that the room is never below a set temperature or above another set temperature. In one example, the temperatures can range from −20° F. to 120° F. For example, the room temperature can be below 30° F. and the safety priority rules can take priority to heat up the room to prevent freezing of the pipes within the room. In another example, the safety priority rules can control the lights, wherein the safety priority rules can override the lights within the room and turn off the lights if the lights are on over a set period of time. The safety priority rules can further control the voltage, current, and/or power supplied to outlets within the room, wherein if a breaker is tripped, or the voltage is reading 0 V or greater than 250 V the safety priority rules can turn off power within the room. In this way, the safety priority rules can protect the safety of the room and any individual within the room.

The control priority engine 600 can further include administrative priority rules 604 that can be set or changed by an administrator of the multitenant instillation. The administrative priority rules can be the priority rules of the room when the RFID card and user is not within the room. Thus, the administrator rules can control the temperature within the room, the voltage, current, and/or power the room can consume and the times the lights can be on or off. For example, the lights can be in an off state during hours between 11 PM to 5 AM and the temperature of the room can be raised or cooled respectively to save energy.

The control priority engine 600 can further include facility optimization priority rules 606. The facility optimization priority rules 606 can further control the temperature, the lights, and the energy output within the multitenant installation. In this way, the facility can optimize the temperature, light use, and voltage, current, and/or power within a room. In this way, the facility type and location can be implemented to optimize the energy usage. In one example, on a hot day, the facility optimization priority rules can override the administrative priority rules and adjust the temperature in the room to match the ideal temp that consumes the least energy.

The control priority engine 600 can further include a user preferences priority rules 608. The user preferences priority rules 608 can take priority over the above-mentioned rules when the user is present in the room and the RFID has been authenticated. In this way, the user's preferences can overcome the administrative priority rules and the facility optimization priority rules. Thus, the user can set their desired temperature for the room and have full access to all electronic devices in the room (e.g., lights, thermostats, outlets, and the like). However, in the control priorities engine 600, the user preferences priority rules 608 are the lowest priority of rules. In this way, if the user has the lights on for more than 12 hours, the facility optimization priority rules can override user preferences priority rules and turn the lights off. In another example, the user can override an outlet, and the safety priority rules can override the user preferences priority rules and shut power off the outlet to prevent a breaker from tripping. In this way, the safety priority rules 602, the administrative priority rules 604, the facility optimization priority rules 606, and the user preferences priority rules 608 can work in conjunction such that the user can be comfortable within the room but minimize the amount of energy waste when the user is not present within the room.

Any of the features, components, and/or parts, of the system or method, including the arrangements and configurations thereof shown in FIG. 6, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 6.

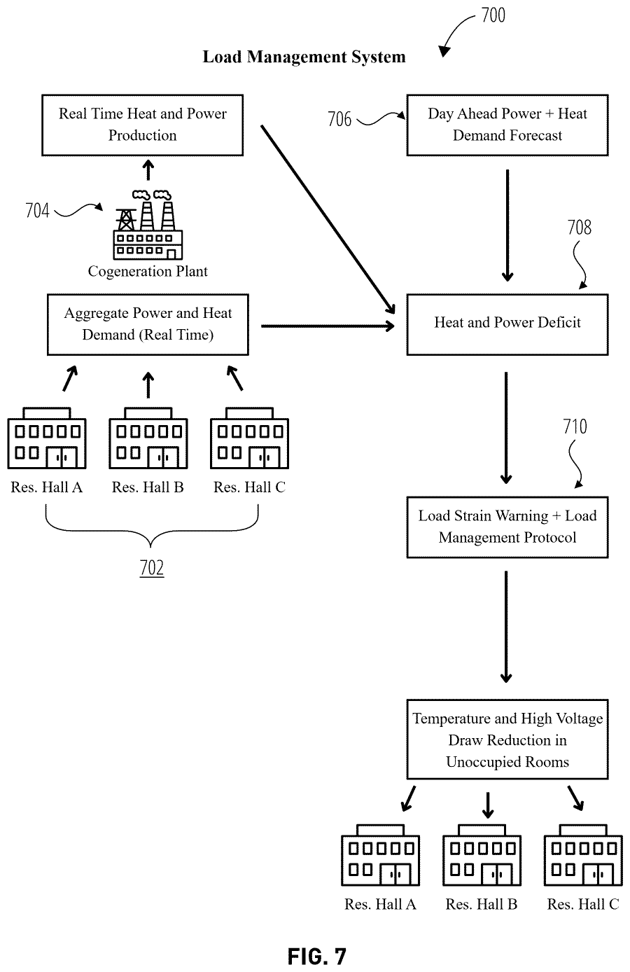

FIG. 7 can illustrate a schematic diagram of a load management system 700. As illustrated in FIG. 7, a set of multitenant instillations 702 can collect power usage data from a plurality of electronic devices that can be communicatively coupled to a centralized control system. The power usage data can be aggregated to compile a real time aggregated power usage data of all the multitenant instillations of the set of multitenant instillations 702. The aggregated power usage data can include data from a room basis, a hall basis, and/or a facility basis.

The set of multitenant instillations 702 can operate within their own cogeneration plants 704. The cogeneration plant 704 can provide real time heat and power production. The aggregated power usage data and the real time heat and power production can be compared against a day ahead power and heat demand forecast 706. The power and heat demand forecast 706 can include data regarding the weather forecast the next day (e.g., a hot day or a cold day) and determine the estimated power and heat demand based on the weather forecast.

The comparison between the aggregated power usage data and the real time heat and power production can produce a heat and power deficit 708. In one example, an extreme hot day or an extreme cold day can create a heat and power deficit. In more detail, the deficit is created because the cogeneration plant 704 cannot produce enough heat and power to accommodate to the day ahead power and heat demand forecast 706. Thus, a load strain warning and load management protocol 710 can be generated. The load strain warning and load management protocol 710 can include temperature and high voltage draw reduction in unoccupied rooms within the set of multitenant instillations 702. In this way, unoccupied rooms can have temperatures lowered or raised respectively, power diverted and the like to prevent heat and power deficits 708. In this way, the load management system 700 can prevent power loss to user that are occupying a room within the multitenant instillation.

Any of the features, components, and/or parts, of the system or method, including the arrangements and configurations thereof shown in FIG. 7, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 7.

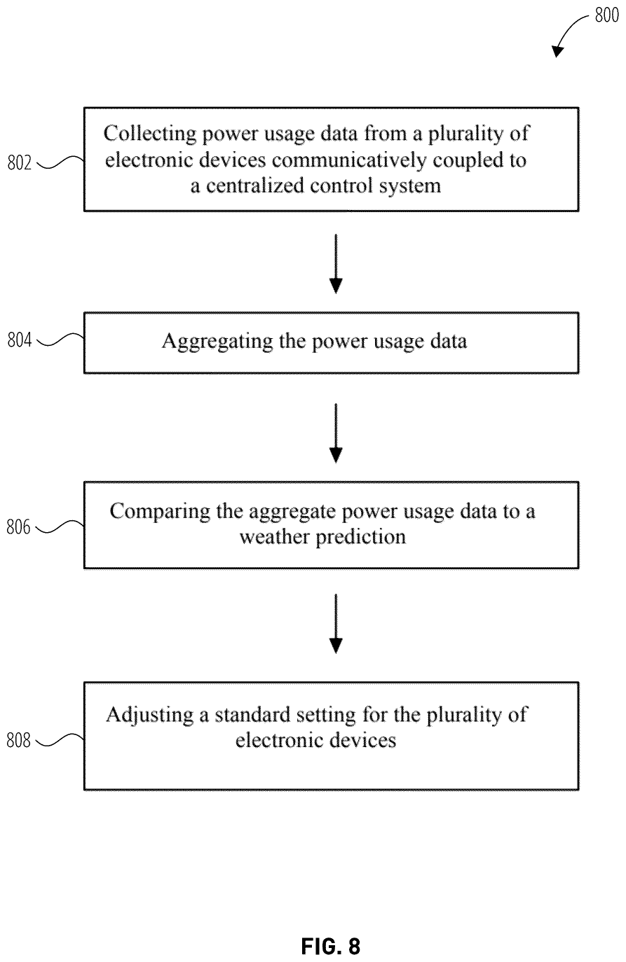

FIG. 8 illustrates a flow chart of a method 800 for collecting and aggregating power usage data. Power usage data from a plurality of electronic devices that are communicatively coupled to a centralized control system can be collected. In block 802, the plurality of electronic device can be thermostats, as discussed above, that can be housed in each room of a multitenant installation. The power usage data of the plurality of electronic devices from each room can be aggregated. In block 804, the aggregated power usage data can then be compared to a weather prediction of the next day. In block 806, as discussed herein in relation to FIG. 7, the aggregated power usage data can be compared with the real time power and heat production of a cogeneration plant and the next day weather prediction. The standard settings for the plurality of electronic devices can be adjusted. In block 808, the power use throughout the whole multitenant installation can be adjusted based on the comparison to avoid power outages.

Any of the features, components, and/or parts, of the system or method, including the arrangements and configurations thereof shown in FIG. 8, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 8.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Further, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples, and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A system comprising:
a housing defining an internal volume;
a display screen coupled to the housing;
a recess defined by the housing;
a processor disposed within the internal volume;
a plurality of input mechanisms; and
an antenna disposed within the internal volume.

2. The system of claim 1, wherein the recess configured to receive at least a portion of a Radio Frequency Identification (RFID) card.

3. The system of claim 1, wherein the processor configured to collect a power usage and environmental data.

4. The system of claim 1, wherein the processor configured to determine a RFID signature of a user.

5. The system of claim 4, wherein the processor configured to determine a user setting based on the RFID signature of the user.

6. The system of claim 5, wherein the user setting comprises at least one of temperature, lights, power usage, or connected electronic devices.

7. The system of claim 1, wherein the plurality of input mechanisms configured to mechanical buttons.

8. The system of claim 1, wherein the plurality of input mechanisms configured to a touch sensitive layer.

9. The system of claim 1, further including an RFID reader disposed in the recess.

10. The system of claim 1, wherein the antenna configured to communicatively couple to electronic devices via Bluetooth or Wi-Fi.

11. A method, comprising:
receiving an RFID card in a recess defined by a housing of an electronic device communicatively coupled to a centralized control system;
determining a user's settings based on a RFID signature; and
communicating the user's settings to electronic devices communicatively coupled to the centralized control system.

12. The method of claim 11, further including controlling a user's settings via the electronic device communicatively coupled to the centralized control system.

13. The method of claim 12, wherein the user's settings comprising:
a user's temperature;
a user's lights; and
a user's operations of electronic devices communicatively coupled to the centralized control system.

14. The method of claim 11, further including changing a standard setting to the user's setting via the RFID signature.

15. The method of claim 11, further including returning the user's settings to the standard setting as the RFID card is removed from the centralized control system.

16. The method of claim 11, further including collecting a power usage as the RFID card received by the housing.

17. The method of claim 16, further including sharing the power usage with electronic devices communicatively coupled to the centralized control system.

18. A method, comprising:
collecting power usage data from a plurality of electronic devices communicatively coupled to a centralized control system;
aggregating the power usage data;
comparing the aggregated power usage data to a weather prediction; and
adjusting a standard setting for the plurality of electronic devices.

19. The method of claim 18, further including viewing the aggregated power usage data from the centralized control system.

20. The method of claim 18, wherein the weather prediction comprises at least one of temperature, humidity, atmospheric pressure, or precipitation.
